(19) United States
(12) Patent Application Publication
(10) Pub. No.: US 2009/0066569 A1
(43) Pub. Date: Mar. 12, 2009

(54) Animal tracking system

(76) Inventors: Andrew James Simpson Hunter, Calgary (CA); Naser El-Sheimy, Calgary (CA); Gordon B. Stenhouse, Hinton (CA); David Bruce Wright, Calgary (CA)

Correspondence Address: Nixon Peabody LLP, 200 Page Mill Road, Palo Alto, CA, 94306, US

(21) Appl. No.: 11/900,397

(22) Filed: Sep. 11, 2007

(51) Int. Cl. H04B 7/185; G06F 19/00

(52) U.S. Cl. 342/357.07; 702/19

(57) ABSTRACT

An apparatus and method for providing effective animal tracking is disclosed. For one embodiment, an animal tracking system includes one or more dead reckoning measurement devices, a storage device coupled to the one or more dead reckoning measurement devices for storing measurements made by the one or more dead reckoning measurement devices, and a digital processing system coupled to the storage device for processing the stored measurements.

### FIELD

Embodiments of the invention relate to animal tracking systems and more specifically, to animal tracking systems integrating dead reckoning positioning sensors and systems.

### BACKGROUND

Conventional animal tracking systems typically employ a satellite-based positioning system, for example, a Global Navigation Satellite System (GNSS) such as the Global Positioning System (GPS). Such systems typically include a GPS receiver to estimate position. Such systems require a visual sighting of the animal being tracked in order to understand what the animal is doing at each location, and therefore interpret why the animal is there. It is often difficult to follow an animal so that only infrequent visuals are practical. Even so, such animal tracking is time consuming and labor intensive.

A disadvantage of such systems is that the satellite signal used to estimate the position of the animal may not be received in various circumstances (e.g., due to certain types/densities of canopy cover). For example a GPS-based animal tracking system typically provides approximately 70%-80% coverage, and sometimes as low as 20%-30% due to canopy induced signal loss. There is also the problem of satellite unavailability, and GPS-based systems provide only a discrete representation of the animal's traveled route. With such systems, the animal's movement paths and movement rate must be inferred from the available GPS data.

Additionally the animal being tracked may be laying on the animal tracking system, thus impairing location determination. Moreover, conventional systems do not allow for continuous trajectories that can provide the opportunity to identify repulsion zones (areas where an animal does not venture). Conventional systems produce discrete locations over a significant time so that assigning animal behavior to a given location is difficult if even possible.

Conventional systems further do not provide information about the activities the animal is engaged. Such information, if available, would greatly improve the understanding of animal movements and habits.

### SUMMARY OF THE INVENTION

Embodiments of the invention provide a method and system for animal tracking and animal activity determination. One embodiment of the invention is an animal tracking system having one or more dead reckoning measurement devices, a storage coupled to the one or more dead reckoning measurement devices for storing measurements made by the one or more dead reckoning measurement devices, and a digital processing system coupled to the storage for processing the stored measurements.

Other advantages and embodiments will be described in the detailed description.

### BRIEF DESCRIPTION OF THE DRAWINGS

The invention may be best understood by referring to the following description and accompanying drawings that are used to illustrate embodiments of the invention. In the drawings:

FIG. 1 illustrates an animal tracking system (ATS) in accordance with one embodiment of the invention;

FIG. 2 illustrates a process for effecting animal tracking in accordance with one embodiment of the invention;

FIG. 3 illustrates a process for automatically determining animal behavior in accordance with one embodiment of the invention; and

FIG. 4 illustrates a functional block diagram of a digital processing system that may be used to communicate data in accordance with one embodiment of the invention.

### DETAILED DESCRIPTION

An apparatus and method for providing animal tracking and activity information to a user. For one embodiment of the invention an animal tracking system (ATS) is disclosed that includes an inertial pedometer, a magnetometer, a real time clock module and a data storage device. In general, embodiments of the invention provide an ATS based on employing dead reckoning (DR) sensors to provide location determination. Embodiments of the invention integrate one or more DR sensor systems with a GNSS positioning system.

For one embodiment of the invention, imaging/audio functionality (e.g., a digital camera and/or digital recorder) is integrated with a GNSS positioning system and one or more DR sensors.

An ATS in accordance with one embodiment of the invention allows a user to correlate specific movements of the animal to behavioral activities and match the activities to the corresponding environment (e.g., through visual data obtained from a digital camera). The user can assess a great deal of information regarding specific movement, location, and environment to determine the activities of an animal in a given landscape. Such capabilities, which are not available in prior art animal tracking schemes, will greatly enhance animal tracking results.

Those of ordinary skill in the art will realize that the following detailed description of various embodiments of the invention is illustrative only and is not intended to be in any way limiting. Other embodiments of the invention will readily suggest themselves to such skilled persons having the benefit of this disclosure. It will be apparent to one skilled in the art that these specific details may not be required to practice embodiments of the invention. In other instances, well-known elements and devices are shown in block diagram form to avoid obscuring the invention. In the following description of the embodiments, substantially the same parts are denoted by the same reference numerals.

In the interest of clarity, not all of the features of the implementations described herein are shown and described. It will, of course, be appreciated that in the development of any such actual implementation, numerous implementation-specific devices must be selected in order to achieve the developer's specific goals, wherein these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with an embodiment of the invention, the components, process operations, and/or data structures may be implemented using various types of operating systems, computing platforms, computer programs, and/or general purpose machines. In addition, those of ordinary skill in the art will recognize that devices of a less general purpose nature may also be used without departing from the scope and spirit of the inventive concepts disclosed herein.

While particular embodiments of the invention have been shown and described, it will now be apparent to those skilled in the art having the benefit of this disclosure that many more modifications than mentioned above are possible without departing from the inventive concepts disclosed herein. Moreover, inventive aspects lie in less than all features of a single disclosed embodiment. Thus, the claims following the Detailed Description are hereby expressly incorporated into this Detailed Description, with each claim standing on its own as a separate embodiment of this invention.

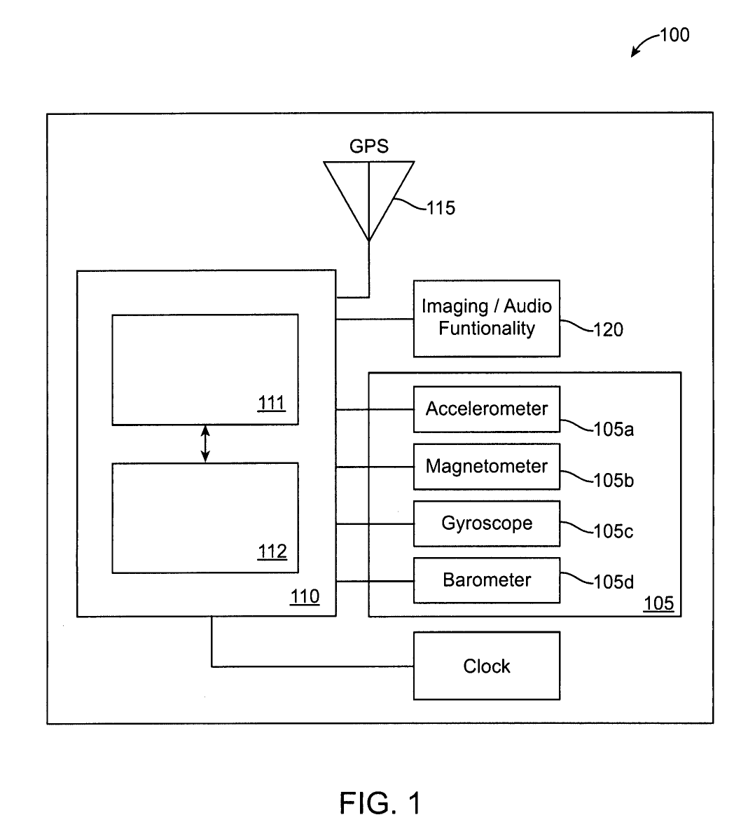

FIG. 1 illustrates a functional block diagram of an ATS integrating a satellite-based positioning system, a DR positioning system, as well as imaging functionality in accordance with one embodiment of the invention. ATS 100 shown in FIG. 1 includes a suite of DR sensors 105, shown for example as 105a-105d. The DR sensors 105 are coupled to a DPS 110, which may include, for example, a processor 111 coupled to, or integrated with a storage 112.

For one embodiment of the invention, an ATS includes a satellite-based navigation functionality, shown for example, as GPS antenna 115 of ATS 100 shown in FIG. 1. For one embodiment of the invention, an ATS includes an imaging functionality, which may be a digital camera. ATS 100, shown in FIG. 1, for example, includes imaging/audio recording functionality 120. For one embodiment of the invention, an ATS includes a real time clock, shown for example, as real time clock 125 of ATS 100 shown in FIG. 1.

In accordance with various alternative embodiments of the invention, the ATS's DR sensor suite includes an accelerometer, which may be a three-axis accelerometer that can be used for obtaining information about the steps of the animal being tracked. In one such embodiment, the DR sensor includes a magnetometer and a real time clock as described above. This configuration provides a step sensor that senses accelerations, primarily forward and downward, that occur each time an animal takes a step. One embodiment of the invention is configured to use the information obtained by the accelerometer to produce a signal (e.g., a sinusoid) representative of the steps taken by the animal. The magnetometer senses the earth's magnetic field parallel to each axis and outputs a set of signals that can be processed by the integrated DPS to provide a representation of the magnetic heading of the ATS. The real time clock is used to provide accurate information as to the timing of the sensor data and to allow synchronization between multiple sensors of the DR sensor suite.

The output of the sensors is received by a computing circuit and stored in the storage of the ATS. Analysis of this data allows a determination of the animal's path based upon the number of steps taken and the heading of each step. For one embodiment of the invention, a digital camera is integrated with the GNSS and DR components, as well as the DPS. For one such embodiment, all of the components are assembled within an animal-proof case, which can be easily attached to a conventional animal tracking collar. In other embodiments, an ATS, in accordance with various embodiments of the invention, may be attached to the animal in a non-conventional manner to take advantage of the increased sensing abilities of the ATS. For example, an ATS in accordance with one embodiment of the invention may be so configured as to be attached on the shoulder of an animal to facilitate obtaining information related to the stride of the animal.

As described above in reference to FIG. 1, the suite of DR sensors includes an accelerometer which may be a tri-axial accelerometer. The accelerometer can be used to measure the vertical movement of the animal or a part of the animal (e.g., the animal's shoulder).

The output of the accelerometer may be a sinusoid with each peak and valley representing a step. This allows a determination of the number of steps taken which can be used to determine the stride length. For one embodiment the ATS includes a magnetometer which may be a tri-axial magnetometer. The magnetometer can be used to determine direction of movement as described above. A barometer may also be included to determine altitude and relative change in altitude. For alternative embodiments of the invention, the DR sensor suite may include any combination of these measurement devices and/or other measurement devices (e.g., gyroscope) for effecting DR positioning.

As described above, the data from the measurement devices and sensors of the ATS may be stored within memory of the DPS within the ATS. In alternative embodiments, the data may be transmitted to a remote DPS for processing. Additionally or alternatively, the data may be processed or partially processed at a DPS of the ATS, and then transmitted to a remote DPS for further processing and/or analysis. For such embodiments, the ATS or various components thereof, may be communicatively coupled to a remote DPS via data communication link. Such a data communication link may be a wired or wireless link including radio telephone links, or network links, for example, which may communicate any combination of a number of different types of data including for example video, audio, graphics, text, multi-media or the like. For example the data may be audio/video data, such as position and location information including images and sound. However, it will be appreciated that the data communicated in accordance with the teachings of various embodiments of the invention are not limited only to audio/video data.

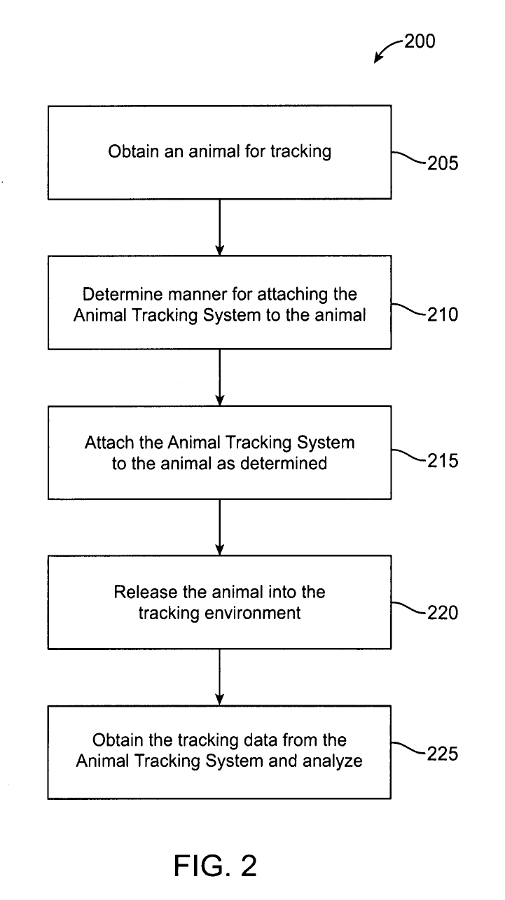

FIG. 2 illustrates a process for effecting animal tracking in accordance with one embodiment of the invention. Process 200, shown in FIG. 2, begins at operation 205 in which an animal to be tracked is obtained or captured. The animal may be a wild animal (including an endangered wildlife species) or a domestic or commercial animal. Depending upon the type of animal, operation 205 may include capturing a wild animal or obtaining a domestic animal for tracking. At operation 210 a determination is made as to how the ATS should be attached to the animal. The ATS may be attached to the animal using a collar fastened around the animals neck. Alternatively, it may be more advantageous to fasten the ATS to the shoulder of the animal, or use a harness to fasten the ATS to the back or leg of the animal. For one embodiment of the invention, the manner in which the ATS is attached to the animal is based upon the context of the animal tracking. For example, if the animal is a wild animal and stride length is deemed important to tracking analysis, the ATS may be attached to the animal's shoulder, while for tracking domestic animals, it may be preferable to attach the ATS to the animal's back or belly.

At operation 215 an ATS in accordance with an embodiment of the invention is attached to the animal in a manner determined at operation 210.

At operation 220, the animal is released into the setting in which the animal is to be tracked. A wild animal may be released into its natural habitat while a commercial animal may be placed in its commercial environment.

After a suitable tracking time, which will depend upon the animal tracking context, the tracking data is obtained at operation 225. For example, for a wild animal, the tracking time may be a season or a year, and the tracking data may be obtained by recapturing the animal to obtain the ATS having the animal tracking data stored in memory therein. Alternatively, the ATS may be designed or programmed to detach from the animal after a given time and may then be retrieved without animal recapture. For embodiments of the invention in which the tracking data is transmitted to a remote DPS, the ATS may not be recovered, but will transmit animal tracking data throughout the time it remains functional.

As discussed above, the data obtained from an ATS in accordance with various embodiments of the invention can be analyzed and used to determine a wide range of animal behavior in various environments. For one embodiment of the invention, determining animal behavior can accomplished automatically using an ATS in accordance with an embodiment of the invention.

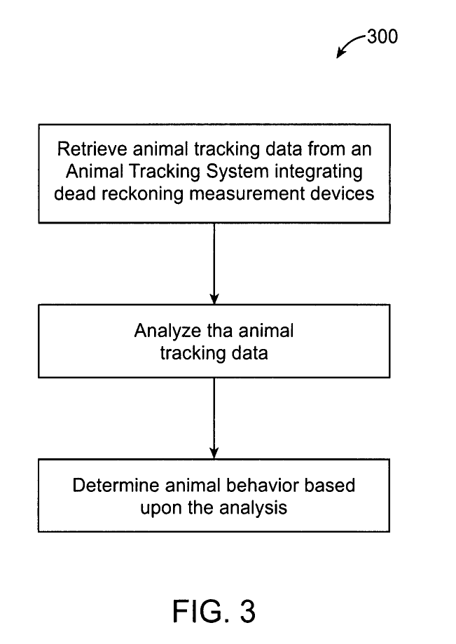

FIG. 3 illustrates a process for automatically determining animal behavior in accordance with one embodiment of the invention. Process 300, shown in FIG. 3 begins at operation 305 in which animal tracking data is received from an ATS in accordance with one embodiment of the invention. For example, the animal tracking data may be received to a remote DPS from an ATS via a communication link as described above.

At operation 310, the data received from the ATS is analyzed. The analysis is based on the tracking context and may be substantially different for different animals and environments. The analysis may consider the range, speed, altitude, relative motion, and sedentary behavior, of the animal as well as the biological and physiological activities of the animal among other characteristics.

At operation 315 the animal's behavior is determined based upon the analysis of the animal tracking data.

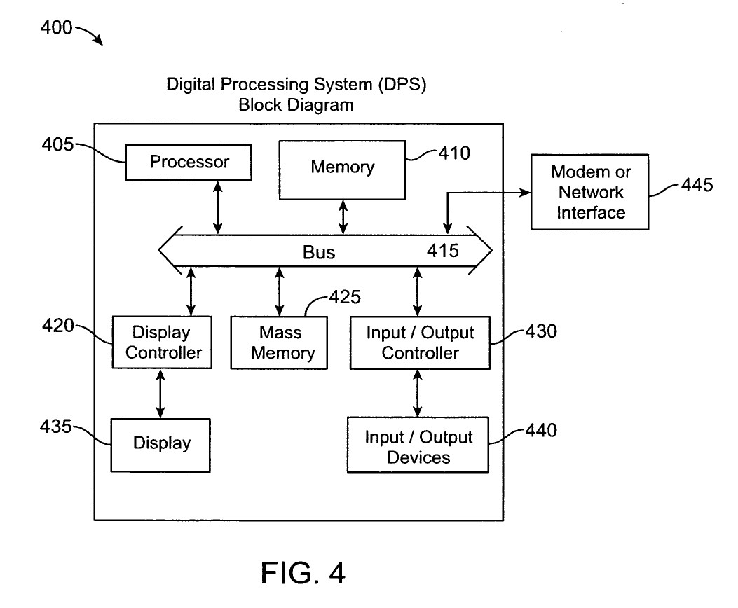

As discussed above, embodiments of the invention may employ DPSs or devices having digital processing capabilities. Such DPSs may be a processor and memory or may be part of a more complex system having additional functionality. FIG. 4 illustrates a functional block diagram of a digital processing system that may be used in accordance with one embodiment of the invention. The components of processing system 400, shown in FIG. 4 are exemplary in which one or more components may be omitted or added. For example, one or more memory devices may be utilized for processing system 400. Referring to FIG. 4, the processing system 400, shown in FIG. 4, may be used as a server processing system. Furthermore, the processing system 400 may be used to perform one or more functions of a communications signal receiver system in accordance with an embodiment of the invention. The processing system 400 may be interfaced to external systems through a network interface or modem 445. The network interface or modem may be considered a part of the processing system 400. The network interface or modem may be an analog modem, an ISDN modem, a cable modem, a token ring interface, a satellite transmission interface, a wireless interface, or other interface(s) for providing a data communication link between two or more processing systems. The processing system 400 includes a processor 405, which may represent one or more processors and may include one or more conventional types of processors, such as Motorola PowerPC processor or Intel Pentium processor, etc. A memory 410 is coupled to the processor 405 by a bus 415. The memory 410 may be a dynamic random access memory (DRAM) and/or may include static RAM (SRAM). The processor 405 may also be coupled to other types of storage areas/memories (e.g. cache, Flash memory, disk, etc.), that could be considered as part of the memory 410 or separate from the memory 410.

The bus 415 further couples the processor 405 to a display controller 420, a mass memory 425 (e.g. a hard disk or other storage which stores all or part of the DR algorithms). The network interface or modem 445, and an input/output (I/O) controller 430. The mass memory 425 may represent a magnetic, optical, magneto-optical, tape, and/or other type of machine-readable medium/device for storing information. For example, the mass memory 425 may represent a hard disk, a read-only or writeable optical CD, etc. The display controller 420 controls, in a conventional manner, a display 435, which may represent a cathode ray tube (CRT) display, a liquid crystal display (LCD), a plasma display, or other type of display device. The I/O controller 430 controls I/O device(s) 440, which may include one or more keyboards, mouse/track ball or other pointing devices, magnetic and/or optical disk drives, printers, scanners, digital cameras, microphones, etc.

The processing system 400 represents only one example of a system, which may have many different configurations and architectures and which may be employed embodiments of the invention. For example, various manufacturers provide systems having multiple busses, such as a peripheral bus, a dedicated cache bus, etc. On the other hand, a network computer, which may be used as a processing system of the present invention, may not include, for example, a hard disk or other mass storage device, but may receive routines and/or data from a network connection, such as the network interface or modem 445, to be processed by the processor 405. Similarly, a portable communication and data processing system, which may employ a cellular telephone and/or paging capabilities, may be considered a processing system that may be used with the present invention. However, such a system may not include one or more I/O devices, such as those described above with reference to I/O device 440.

In the system 400 shown in FIG. 4, the mass memory 425 (and/or the memory 410) may store data that may be processed according to the present invention. For example, the mass memory 425 may contain a database storing previously determined personal navigation and location information and ATS-related algorithms in accordance with one embodiment of the invention. Alternatively, data may be received by the processing system 400, for example, via the network interface or modem 445, and stored and/or presented by the display 435 and/or the I/O device(s) 440. In one embodiment, data may be transmitted across a data communication network, such as a LAN and/or the Internet.

### General Matters

Embodiments of the invention provide an ATS for providing animal tracking and activity information to a user. For one embodiment of the invention an ATS includes an inertial pedometer, a magnetometer, a real time clock module and a data storage device. In general, embodiments of the invention provide an ATS based on employing DR sensors to provide location determination. Embodiments of the invention integrate one or more DR sensor systems with a GNSS positioning system. For one embodiment of the invention, imaging/audio functionality (e.g., a digital camera and/or digital recorder) is integrated with a GNSS positioning system and one or more DR sensors. Such ATSs allow users to correlate specific movements of the animal to behavioral activities and match the activities to the corresponding environment (e.g., through visual data obtained from a digital camera). The user can assess a great deal of information regarding specific movement, location, and environment to determine the activities of an animal in a given landscape.

For one embodiment of the invention, all of the components can be remotely activated or deactivated. Alternatively, the ATS can be programmed to activate/deactivate any of the components of the ATS at desired times.

An embodiment of the invention provides a method for obtaining and analyzing animal tracking data. For one embodiment of the invention, the ATS provides a continuous trajectory for the animal with or without satellite-based positioning.

Embodiments of the invention include various operations such as determining, processing, and communicating data. For various embodiments, one or more operations described may be added or deleted. The operations of the invention may be performed by hardware components or may be embodied in machine-executable instructions, which may be used to cause a general-purpose or special-purpose processor or logic circuits programmed with the instructions to perform the operations. Alternatively, the operations may be performed by a combination of hardware and software. Embodiments of the invention may be provided as a computer program product that may include a machine-readable medium having stored thereon instructions, which may be used to program a computer (or other electronic devices) to perform a process according to the invention. The machine-readable medium may include, but is not limited to, optical disks, CD-ROMs, and magneto-optical disks, ROMs, RAMs, EPROMs, EEPROMs, magnetic or optical cards, flash memory, or other type of media/machine-readable medium suitable for storing electronic instructions. Moreover, the invention may also be downloaded as a computer program product, wherein the program may be transferred from a remote computer to a requesting computer by way of data signals embodied in a carrier wave or other propagation medium via a communication cell (e.g., a modem or network connection).

Further, though described for various embodiments in specific context, embodiments of the invention are applicable to a variety of single channel or multi-channel data transfer systems employing multiple data standards.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An animal tracking apparatus comprising:
one or more dead reckoning measurement devices;
a storage coupled to the one or more dead reckoning measurement devices for storing measurements made by the one or more dead reckoning measurement devices; and
a digital processing system coupled to the storage for processing the stored measurements.

2. The animal tracking apparatus of claim 1 further comprising a receiver for a satellite-based positioning system coupled to the digital processing system.

3. The animal tracking apparatus of claim 2 wherein the one or more dead reckoning measurement devices includes one or more measurement devices selected from the group consisting of accelerometer, magnetometer, gyroscope, and barometer.

4. The animal tracking apparatus of claim 3 wherein the accelerometer is a tri-axial accelerometer, the magnetometer is a tri-axial magnetometer, and the gyroscope comprises three orthogonal gyroscopes.

5. The animal tracking apparatus of claim 1 further comprising:
an attachment mechanism for attaching the animal tracking apparatus to an animal.

6. The animal tracking apparatus of claim 5 wherein the animal is a type of animal selected from the group consisting of wild animals, domestic animals, and commercial animals.

7. The animal tracking apparatus of claim 5 wherein the attachment mechanism is selected from the group consisting of collar, shoulder harness, back strap, and leg strap.

8. The animal tracking apparatus of claim 1 further comprising:
an imaging and audio functionality.

9. The animal tracking apparatus of claim 1 further comprising:
a real time clock.

10. The animal tracking apparatus of claim 1 wherein the digital processing system is communicatively coupled to a remote digital processing system.

11. A method comprising:
obtaining an animal for tracking;
determining a manner for attaching an animal tracking system to the animal, the animal tracking system including one or more dead reckoning measurement devices, a storage coupled to the one or more dead reckoning measurement devices for storing measurements made by the one or more dead reckoning measurement devices, and a digital processing system coupled to the storage for processing the stored measurements;
attaching the animal tracking system to the animal as determined;
releasing the animal into the tracking environment; and
obtaining the tracking data from the animal tracking system.

12. The method of claim 11 wherein the animal is a wild animal and obtaining includes capturing the animal.

13. The method of claim 11 wherein determining the manner of attaching the animal tracking system to the animal is based upon a context of the animal tracking.

14. The method of claim 11 wherein the animal tracking system includes a receiver for a satellite-based positioning system coupled to the digital processing system.

15. The method of claim 14 wherein the one or more dead reckoning measurement devices includes one or more measurement devices selected from the group consisting of accelerometer, magnetometer, gyroscope, and barometer.

16. The method of claim 15 wherein the accelerometer is a tri-axial accelerometer, the magnetometer is a tri-axial magnetometer, and the gyroscope comprises three orthogonal gyroscopes.

17. The method of claim 11 wherein the animal tracking system includes an imaging and audio functionality.

18. The method of claim 11 wherein the animal tracking system includes a real time clock.

19. A method comprising:
retrieving animal tracking data from an animal tracking system, the animal tracking system including one or more dead reckoning measurement devices, a storage coupled to the one or more dead reckoning measurement devices for storing measurements made by the one or more dead reckoning measurement devices, and a digital processing system coupled to the storage for processing the stored measurements;
analyzing the animal tracking data; and
determining animal behaviour based upon the analysis of the animal tracking data.

20. The method of claim 19 wherein the animal tracking system includes a receiver for a satellite-based positioning system coupled to the digital processing system.

21. The method of claim 20 wherein the one or more dead reckoning measurement devices includes one or more measurement devices selected from the group consisting of accelerometer, magnetometer, gyroscope, and barometer.

22. The method of claim 21 wherein the accelerometer is a tri-axial accelerometer, the magnetometer is a tri-axial magnetometer, and the gyroscope comprises three orthogonal gyroscopes.

23. The method of claim 19 wherein the animal tracking system includes an imaging and audio functionality.

24. The method of claim 19 wherein the animal tracking system includes a real time clock.

25. A machine-readable medium that provides executable instructions, which when executed by a processor, cause the processor to perform a method, the method comprising:
retrieving animal tracking data from an animal tracking system, the animal tracking system including one or more dead reckoning measurement devices, a storage coupled to the one or more dead reckoning measurement devices for storing measurements made by the one or more dead reckoning measurement devices, and a digital processing system coupled to the storage for processing the stored measurements;
analyzing the animal tracking data; and
determining animal behaviour based upon the analysis of the animal tracking data.

26. The machine-readable medium of claim 25 wherein the animal tracking system includes a receiver for a satellite-based positioning system coupled to the digital processing system.

27. The machine-readable medium of claim 26 wherein the one or more dead reckoning measurement devices includes one or more measurement devices selected from the group consisting of accelerometer, magnetometer, gyroscope, and barometer.

28. The machine-readable medium of claim 27 wherein the accelerometer is a tri-axial accelerometer, the magnetometer is a tri-axial magnetometer, and the gyroscope comprises three orthogonal gyroscopes.

29. The machine-readable medium of claim 25 wherein the animal tracking system includes an imaging and audio functionality.

30. The machine-readable medium of claim 25 wherein the animal tracking system includes a real time clock.
